(19) United States
(12) Patent Application Publication
(10) Pub. No.: US 2024/0359530 A1
(43) Pub. Date: Oct. 31, 2024

(54) VEHICLE CLIMATE CONTROL SYSTEM AND METHOD FOR CONTROLLING THE SAME

(71) Applicant: Mitsubishi Electric Automotive America, Inc., Mason, OH (US)

(72) Inventors: Michael Deen HORANI, Troy, MI (US); Sana JAFRI, Farmington Hills, MI (US); Hirotaka MINATO, Livonia, MI (US)

(21) Appl. No.: 18/308,412

(22) Filed: Apr. 27, 2023

(51) Int. Cl. B60H 1/00

(52) U.S. Cl. CPC B60H 1/00742; B60H 1/0073; B60H 1/00985; B60H 2001/00733; B60N 2/5678

(57) ABSTRACT

A vehicle climate control system is provided, including: a vehicle controller; a memory configured to store one or more temperature set points for the inside of a vehicle; a plurality of vehicular sensors including one or more thermal sensors configured to collect temperature data; and a plurality of climate circuits configured to control a climate inside the vehicle. The one or more thermal sensors are each configured to measure a body temperature of an occupant and an internal temperature of an interior of the vehicle. The vehicle controller is configured to control the plurality of climate circuits based on the body temperature of the occupant, at least one of the one or more temperature set points, and the internal temperature of an interior of the vehicle.

### TECHNICAL FIELD

The disclosed systems and methods relate generally to vehicle climate systems. More particularly, the disclosed systems and methods relate to vehicle climate systems that use internal thermal sensors to identify temperatures of the occupants of a vehicle and locations in the vehicle and adjust climate controls based, in part, on these temperatures.

### BACKGROUND

Vehicle climate systems are provided to maintain the interior of a vehicle at a comfortable temperature regardless of the temperature outside of the vehicle. The climate system will heat the interior of the vehicle when it is cold outside the vehicle and will cool the interior of the vehicle when it is hot outside.

An occupant of the vehicle can provide the climate system with different pieces of information for operation that may include a desired set point temperature, a desired temperature range, whether the climate system should operate in a cooling or heating mode, or the like. The vehicle climate uses this information to maintain the inside of the vehicle at a temperature that will make the occupant comfortable.

Often a vehicle will have multiple occupants, each of whom may have different preferences regarding temperature. These individual occupants may have different tolerances to temperature, which can result in the occupants of a vehicle desiring different temperatures in different parts of the vehicle. A vehicle climate system may therefore be designed to maintain different temperatures in different parts of the vehicle.

It is therefore desirable to provide a vehicle climate system that provides different climate control in different parts of the vehicle corresponding to different occupants, e.g., different seat positions. It is also desirable to provide a vehicle climate control system that can operate the vehicle climate system with sufficient accuracy to maintain the temperature in each portion of the vehicle at a temperature or temperature range that will be comfortable for each occupant.

### SUMMARY OF THE INVENTION

According to one or more embodiments, a vehicle climate control system is provided, comprising: a vehicle controller; a memory configured to store one or more temperature set points for the inside of a vehicle; a plurality of vehicular sensors including one or more thermal sensors configured to collect temperature data; and a plurality of climate circuits configured to control a climate inside the vehicle, wherein the one or more thermal sensors are each configured to measure a body temperature of an occupant and an internal temperature of an interior of the vehicle, and the vehicle controller is configured to control the plurality of climate circuits based on the body temperature of the occupant, at least one of the one or more temperature set points, and the internal temperature of an interior of the vehicle.

The climate circuits may include one or more vehicle heating, ventilation, and air-conditioning (HVAC) circuits and one or more comfort circuits.

The comfort circuits may include at least one of a steering wheel heater, a seat heater, a ventilator, and a neck warmer.

The interior of the vehicle may be divided up into two or more zones, and the vehicle HVAC circuits may include two or more zone HVAC circuits, each of the two or more zone HVAC circuits corresponding to one of the two or more zones.

The interior of the vehicle may divided up into two or more zones, and the climate circuits may include two or more vehicle heating, ventilation, and air-conditioning (HVAC) circuits, each of the two or more HVAC circuits corresponding to one of the two or more zones,
the one or more thermal sensors include two or more thermal sensors, each of the two or more thermal sensors corresponding to one of the two or more zones,
the two or more thermal sensors are each configured to measure a body temperature of an occupant in a corresponding zone and an internal temperature of the interior of the vehicle in the corresponding zone,
the vehicle controller is configured to control each of the two or more HVAC circuits based the body temperature of the occupant in the corresponding zone, the internal temperature of an interior of the vehicle in the corresponding zone, and at least one of the one or more temperature set points corresponding to the zone.

The vehicle climate control system may further comprise an external temperature sensor configured to measure an external temperature immediately outside of the vehicle, wherein, the vehicle controller is configured to control the plurality of climate circuits based on the body temperature of the occupant, the internal temperature of an interior of the vehicle, at least one of the one or more temperature set points, and the external temperature immediately outside of the vehicle.

The vehicle climate control system may further comprise a human-machine-interface configured to receive information and instructions from the occupant and to provide the information and the instructions from the occupant to the vehicle controller, wherein, the vehicle controller is configured to control the plurality of climate circuits based on the body temperature of the occupant, the internal temperature of an interior of the vehicle, at least one of the one or more temperature set points, and the information and instructions received from the occupant.

The plurality of vehicle sensors may further include at least one of a radar sensor, a microphone sensor, an image camera, and an infrared camera.

The vehicle controller may be configured to determine whether the occupant is a human being based on information from the plurality of vehicular sensors.

The vehicle controller may be configured to identify whether the occupant is a child based on the information from the plurality of vehicular sensors, and the vehicle controller may be configured to identify whether there are no adults in the vehicle based on the information from the plurality of vehicular sensors.

The vehicle controller may be configured to implement an unattended child protocol to maintain a temperature inside the vehicle within a set temperature range when the vehicle controller identifies that the occupant is a child and that no adult is in the vehicle.

A method of controlling a vehicle climate control system is also provided, the method comprising: setting a current operation mode for a vehicle and one or more zone temperature set points for the vehicle, an interior of the vehicle being divided into one or more zones and the one or more zone temperature set points each corresponding to one of the one or more zones; receiving first preference data corresponding to a first zone in the vehicle, the first zone being selected from the one or more zones, the first preference data indicating a first desired temperature or first desired temperature range for the first zone; gathering data from one or more internal sensors inside the vehicle, the internal sensors including at least one thermal sensor; identifying the presence of a first occupant in the first zone using information from the one or more internal sensors; determining a first body temperature of the first occupant using information from the at least one thermal sensor; determining a first zone temperature of the first zone using information from the at least one thermal sensor; determining required changes to the system parameters to maintain the first desired temperature or first desired temperature range in the first zone based on the first preference data, the first body temperature, and at least one of: the current operation mode, a first set point selected from the one or more zone temperature set points and corresponding to the first zone, and the first zone temperature; and modifying the system parameters based on the determining of required changes to the system parameters to maintain the first desired temperature or the first desired temperature range.

The method may further comprise measuring an outdoor temperature immediately outside of the vehicle, wherein the determining of the required changes to the system parameters is performed based on the first preference data, the first body temperature and at least one of: the current operation mode, the first set point, the estimated first body temperature, the first zone temperature, and the outdoor temperature.

The method may further comprise: gathering first body data of the first occupant using information from the at least one or more internal sensors, the first body data identifying a physical parameter of the first occupant. The determining of the required changes to the system parameters to maintain the first desired temperature or the first desired temperature range in the first zone may be performed based on the first preference data, the first body temperature, the first body data, and at least one of: the current operation mode, a first set point selected from the one or more zone temperature set points and corresponding to the first zone, and the first zone temperature.

The first body data may include one of: an indication of whether the first occupant is shivering, an indication of whether the first occupant has goosebumps on their skin, and an indication of whether the first occupant is sweating.

The method may further comprise determining that the first occupant is human using information from the one or more internal sensors prior to the estimating of the first body temperature of the first occupant.

The operations of gathering the data from the one or more internal sensors inside the vehicle, identifying the presence of the first occupant in the first zone, determining the first body temperature of the first occupant, determining the first zone temperature, determining of the required changes to the system parameters to maintain the desired temperature or temperature range, and modifying the system parameters based on the determining of required changes to the system parameters may be repeated throughout operation of the vehicle climate control system.

The method may further comprise receiving second preference data corresponding to a second zone in the vehicle, the second zone being selected from the one or more zones and being different from the first zone, the second preference data indicating a desired temperature or temperature range for the second zone; identifying the presence of a second occupant in the second zone using information from the one or more internal sensors; determining a second body temperature of the second occupant using information from the at least one thermal sensor; determining a second zone temperature of the second zone using information from the at least one thermal sensor; determining required changes to the system parameters to maintain the second desired temperature or the second desired temperature range in the second zone based on the second preference data, the second body temperature, and at least one of: the current operation mode, a second set point selected from the one or more zone temperature set points and corresponding to the second zone, and the second zone temperature; and modifying the system parameters based on the determining of required changes to the system parameters to maintain the second desired temperature or the second desired temperature range.

The zones may include a driver zone, a front passenger zone, a left rear passenger zone, and a right rear passenger zone.

The zones may include an entire car zone that further includes the driver zone, the front passenger zone, the left rear passenger zone, and the right rear passenger zone.

The method may further comprise determining that activation of one or more comfort components is warranted based on the first preference data, the first body temperature, and at least one of: the current operation mode, a first set point selected from the one or more zone temperature set points and corresponding to the first zone, and the first zone temperature; and activating one or more comfort components after determining that the activation of the one or more comfort components is warranted.

The method may further comprise determining that modifying one or more comfort parameters relating to one or more comfort components is warranted based on the first preference data, the first body temperature, and at least one of: the current operation mode, a first set point selected from the one or more zone temperature set points and corresponding to the first zone, the estimated first body temperature, and the first zone temperature; and modifying the one or more comfort parameters after determining that modifying the one or more comfort parameters relating to the one or more comfort components is warranted.

The one or more comfort components may include one or more of a steering wheel heater, a seat heater, a ventilator, and a neck warmer.

The method may further comprise determining that the first occupant is a child using information from the one or more internal sensors; determining that the vehicle does not contain any adult occupants using information from the one or more internal sensors; and controlling one or more climate circuits in the vehicle according to an unattended child protocol that maintains the first zone temperature within a predetermined range after determining that the first occupant is a child, and that the vehicle does not contain any adult occupants.

A computer system is also provided that is configured to control a vehicle climate control system including one or more climate circuits configured to control a climate in an interior of a vehicle and one or more internal sensors inside the vehicle that include one or more thermal sensors, the system comprising: a communication interface configured to transmit and receive data and control signals to and from the one or more internal sensors and the one or more climate circuits; a memory configured to store data and instructions; and a processor cooperatively operable with the communication interface and the memory, and configured to facilitate: setting a current operation mode for the vehicle and one or more zone temperature set points for the vehicle, the interior of the vehicle being divided into one or more zones and the one or more zone temperature set points each corresponding to one of the one or more zones; receiving first preference data corresponding to a first zone in the vehicle, the first zone being selected from the one or more zones, the first preference data indicating a first desired temperature or first desired temperature range for the first zone; receiving sensor data from the one or more internal sensors; identifying the presence of a first occupant in the first zone of the vehicle using the sensor data from the one or more internal sensors; determining a first body temperature of the first occupant using information from the at least one thermal sensor; determining a first zone temperature of the first zone using information from the at least one thermal sensor; determining required changes to the system parameters to maintain the first desired temperature or first desired temperature range in the first zone based on the first preference data, the first body temperature, and at least one of: the current operation mode, a first set point selected from the one or more zone temperature set points and corresponding to the first zone, and the first zone temperature; and modifying the system parameters based on the determining of required changes to the system parameters to maintain the first desired temperature or the first desired temperature range.

The vehicle climate control system may further include an external temperature sensor configured to measure an outdoor temperature immediately outside of the vehicle, the processor may be further configured to facilitate receiving the outdoor temperature from the external temperature sensor, and the determining of the required changes to the system parameters may be performed based on the first preference data, the first body temperature, and at least one of: the current operation mode, a first set point selected from the one or more zone temperature set points and corresponding to the first zone, the first zone temperature, and the outdoor temperature.

The processor may be further configured to facilitate determining that the first occupant is human using information from the one or more internal sensors prior to the estimating of the first body temperature of the first occupant.

The processor may be is further configured such that the processor repeats the operations of gathering the data from the one or more internal sensors inside the vehicle, identifying the presence of the first occupant in the first zone, determining the first body temperature of the first occupant, determining the first zone temperature, determining of required changes to the system parameters to maintain the desired temperature or temperature range, and modifying the system parameters based on the determining of the required changes to the system parameters throughout operation of the vehicle climate control system.

The processor may be further configured to facilitate receiving second preference data corresponding to a second zone in the vehicle, the second zone being selected from the one or more zones and being different from the first zone, the second preference data indicating a desired temperature or temperature range for the second zone; identifying the presence of a second occupant in the second zone using information from the one or more internal sensors; determining a second body temperature of the second occupant using information from the at least one thermal sensor; determining a second zone temperature of the second zone using information from the at least one thermal sensor; determining required changes to the system parameters to maintain the second desired temperature or the second desired temperature range in the second zone based on the second preference data, the second body temperature, and at least one of: the current operation mode, a second set point selected from the one or more zone temperature set points and corresponding to the second zone, and the second zone temperature; and modifying the system parameters based on the determining of required changes to the system parameters to maintain the second desired temperature or the second desired temperature range.

The zones may include a driver zone, a front passenger zone, a left rear passenger zone, and a right rear passenger zone.

The zones may include an entire car zone that further includes the driver zone, the front passenger zone, the left rear passenger zone, and the right rear passenger zone.

The processor may be further configured to facilitate determining that activation of one or more comfort components is warranted based on the first preference data, the first body temperature, and at least one of: the current operation mode, a first set point selected from the one or more zone temperature set points and corresponding to the first zone, and the first zone temperature; and activating one or more comfort components after determining that the activation of the one or more comfort components is warranted.

The processor may be further configured to facilitate determining that modifying one or more comfort parameters relating to one or more comfort components is warranted based on the first preference data, the first body temperature, and at least one of: the current operation mode, a first set point selected from the one or more zone temperature set points and corresponding to the first zone, the estimated first body temperature, and the first zone temperature; and modifying the one or more comfort parameters after determining that modifying the one or more comfort parameters relating to the one or more comfort components is warranted.

The one or more comfort components include one or more of a steering wheel heater, a seat heater, a ventilator, and a neck warmer.

The processor may be further configured to facilitate determining that the first occupant is a child using information from the one or more internal sensors; determining that the vehicle does not contain any adult occupants using information from the one or more internal sensors; and controlling one or more climate circuits in the vehicle according to an unattended child protocol that maintains the first zone temperature within a predetermined range after determining that the first occupant is a child and that the vehicle does not contain any adult occupants.

### BRIEF DESCRIPTION OF THE DRAWINGS

The accompanying figures, where like reference numerals refer to identical or functionally similar elements and which together with the detailed description below are incorporated in and form part of the specification, serve to further illustrate an exemplary embodiment and to explain various principles and advantages in accordance with the present disclosure.

FIG. 1 is a block diagram of a vehicle climate control system according to disclosed embodiments;

FIG. 2 is a block diagram of the vehicle controller of FIG. 1 according to disclosed embodiments;

FIG. 3 is a block diagram of the climate circuits of FIG. 1 according to disclosed embodiments;

FIG. 4 is a block diagram of the vehicle HVAC circuits of FIG. 3 according to disclosed embodiments;

FIG. 5 is a plan view of a vehicle whose climate is controlled by the vehicle climate control system of FIG. 1 according to disclosed embodiments;

FIGS. 6A and 6B are a flowchart showing the operation of a vehicle climate control system according to disclosed embodiments; and

FIG. 7 is a flowchart showing an operation of identifying an unattended child in a vehicle according to disclosed embodiments.

### DETAILED DESCRIPTION

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, may be supported with or in integrated circuits (ICs), such as dynamic random access memory (DRAM) devices, static random access memory (SRAM) devices, or the like. In particular, they may be implemented using CMOS transistors. It is expected that one of ordinary skill, notwithstanding possibly significant effort and many design choices motivated by, for example, available time, current technology, and economic considerations, when guided by the concepts and principles disclosed herein will be readily capable of generating such ICs with minimal experimentation. Therefore, in the interest of brevity and minimization of any risk of obscuring the principles and concepts according to the present invention, further discussion of such ICs will be limited to the essentials with respect to the principles and concepts used by the exemplary embodiments.

### Vehicle Climate Control System

FIG. 1 is a block diagram of a vehicle climate control system 100 according to disclosed embodiments. The vehicle climate control system 100 is configured to control the climate within a vehicle. As shown in FIG. 1, the vehicle climate control system 100 includes a vehicle controller 110, a plurality of thermal sensors 120, one or more radar sensors 130, one or more microphone sensors 135, one or more camera sensors 140, a human machine interface 145, and a plurality of climate circuits 150.

The vehicle controller 110 is configured to control the operation of the climate control system 100. It receives data from and provides control signals to the plurality of thermal sensors 120, the one or more radar sensors 130, the one or more microphone sensors 135, the one or more camera sensors 140, the human machine interface 145, and the plurality of climate circuits 150.

The plurality of thermal sensors 120 are placed at different locations in the interior of the vehicle and are configured to measure temperatures at various positions inside the vehicle. These thermal sensors 120 can be implemented, by way of example, using thermistors (i.e., thermally sensitive resistors), thermocouples, resistance temperature detectors (RTD), or infrared devices. FIG. 1 discloses the use of the N thermal sensors 125, designated as a first thermal sensor (S-1) 125-1, a second thermal sensor (S-2) 125-2, through an N^{th} thermal sensor (S-N) 125-N. The precise number of thermal sensors 125 used depends upon exactly how the vehicle climate control system 100 is configured.

In some exemplary embodiments, the interior of the vehicle could be divided up into a plurality of zones, some or all of the zones having one or more thermal sensors 125 arranged to detect temperatures within that zone. In other embodiments, the interior of the vehicle could be considered a single zone in which the thermal sensors 125 operate.

In various embodiments, the thermal sensors 125 can be configured to detect a variety of temperatures, e.g., a temperature of an occupant in a corresponding zone, a temperature of the air in a corresponding zone, a temperature of an object within corresponding zone (e.g., a seat, a steering wheel, etc.), or the like.

The one or more radar sensors 130 are circuits that use radar to detect a variety of parameters including, the presence of occupants inside a vehicle, the position of occupants inside the vehicle, the number of occupants inside the vehicle, whether objects are being inserted from outside the vehicle through the windows of the vehicle, where sound is coming from (e.g., driver's seat, front passenger seat, middle right passenger seat, etc.), or any other parameter could be detectable using a radar sensor 130.

The one or more microphone sensors 135 are circuits that detect sound and allow the vehicle processor to use that sound for a variety of purposes including voice recognition, identifying the presence of nearby sirens, detecting breaking glass, or the like. The microphone sensors 135 can also detect where the sound is coming from, e.g., from the driver, from the front passenger, from the right middle passenger, etc.

The one or more camera sensors 140 are circuits that use video sensors along a variety of spectrums. They can include visible-light cameras or infrared cameras. The camera sensors 140 can detect the presence of an occupant, the location of an occupant, whether an occupant is drowsy, whether an occupant is using their mobile phone, or the like. An infrared camera allows for the gathering of this information in situations in which the interior of the vehicle is dark, e.g., at nighttime, in a tunnel, etc.

The human-machine interface 145 allows the occupants of the vehicle to provide data to and receive information from the vehicle controller 110. In various embodiments, the human-machine interface can include a touchpad, a keyboard, a display with touch buttons, or any suitable device for allowing communication between the vehicle controller 110 and the occupants.

In some embodiments, the human-machine interface 145 can coordinate with the microphone sensors 135 or had a microphone in addition to the microphone sensors 135 to obtain and analyze voice data for voice recognition to retrieve instructions from an occupant.

In some embodiments the human-machine interface 145 is configured as a single interface circuit, e.g., a touchpad on the dashboard. In alternate embodiments, the human-machine interface 145 may be configured as multiple interface circuits, e.g., an interface circuits in each zone, a plurality of interface circuits shared between zones, an interface circuit in each row of seats, regardless of how many zones each row is divided into, etc. If multiple interface circuits are used, they need not all be the same type of interface circuit.

The plurality of climate circuits 150 operate to control the climate both in the vehicle in general, and in individual zones within the vehicle. The climate circuits 150 can operate to directly control temperature in the vehicle in general or in a particular zone in the vehicle in specific, e.g., as an HVAC circuit. Alternatively, the climate circuits 150 can provide ancillary comforts to the occupants of the vehicle, e.g., by warming their seats, warming the steering wheel, warming their necks, providing heat from a door panel heater, warming their armrest, etc. In this way, the plurality of climate circuits 150 operate to maintain the comfort of the occupants of the vehicle.

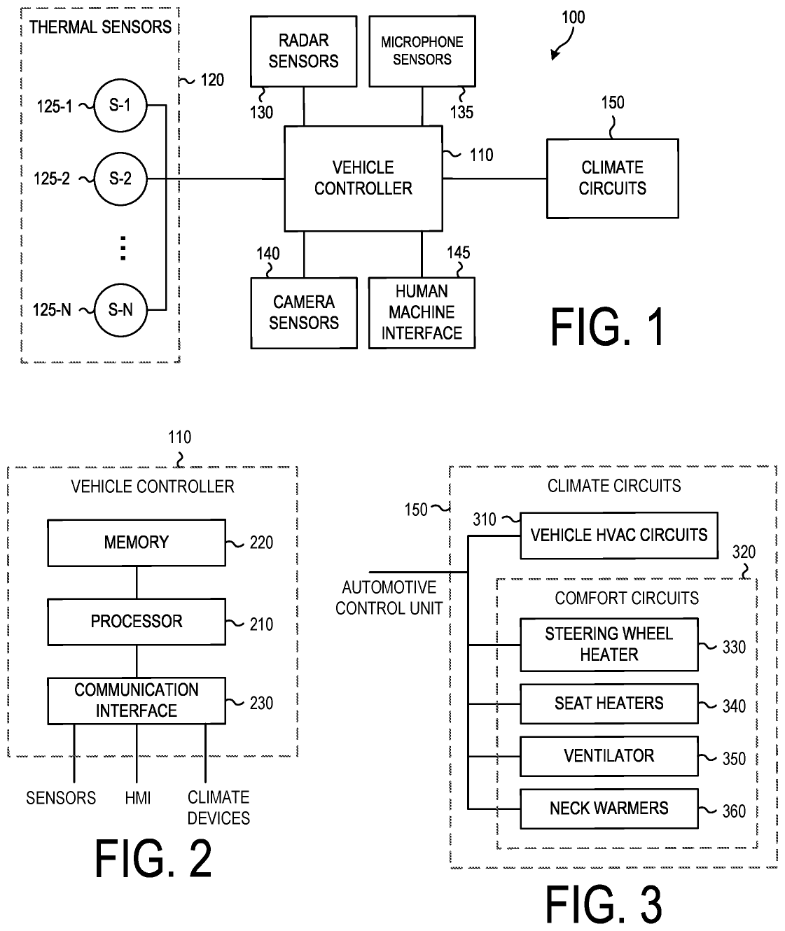

FIG. 2 is a block diagram of the vehicle controller 110 of FIG. 1 according to disclosed embodiments. As shown in FIG. 2, the vehicle controller 110 can include a processor 210, a memory 220, and a communication interface 230.

The processor 210 receives signals from and generates signals to control the sensors 120, 130, 135, 140, the human-machine-interface 145, the climate circuits 150, and any other circuit that requires control signals. The processor 210 can be a microprocessor (e.g., a central processing unit), an application-specific integrated circuit (ASIC), or any suitable device for controlling the operation of all or part of the vehicle climate control system 100.

The memory 220 is configured to store information and operation programs. The memory 220 can include a read-only memory (ROM), a random-access memory (RAM), an electronically programmable read-only memory (EPROM), an electrically erasable programmable read only memory (EEPROM), flash memory, or any suitable memory device.

The communications interface 230 is configured to transmit and receive communications over at least a portion of the vehicle climate control system 100. Although it is only shown in FIG. 1 as having signal lines connecting it to the sensors 120, 130, 135, and 140, the human-machine-interface 145, and the climate circuits 150, this is simply for ease of disclosure. The communications interface 230 would also have a communication connection to any element in the vehicle climate control system 100 that requires instructions from the controller 210 or provides data to the controller 210. This could include, but is not limited to, an outdoor temperature sensor, internal speakers, or any other element within the vehicle climate control system that needs instructions or provides data.

The connection implemented by the communication interface 230 could be wired or wireless between the communications interface 230 and any element in the vehicle climate control system 100 in various embodiments. In some embodiments the connections can be a mix of wired and wireless connections.

FIG. 3 is a block diagram of the climate circuits 150 of FIG. 1 according to disclosed embodiments. As shown in FIG. 3, the climate circuits 150 include one or more vehicle heating, ventilation, and air conditioning (HVAC) circuits 310 and a plurality of comfort circuits 320. The comfort circuits 320 operate to improve the comfort of vehicle occupants, though they are not HVAC circuits. The comfort circuits 320 include a steering wheel heater 330, one or more seat heaters 340, a ventilator 350, and one or more neck warmers 360.

The one or more vehicle HVAC circuits 310 are conventional vehicular HVAC circuits configured to control the temperature of all or part of the interior of a vehicle. In embodiments in which the interior of the vehicle is broken up into zones, each zone may have its own HVAC circuit configured to control the temperature in a corresponding zone, some zones may have their own HVAC circuits while other zones do not, the entire vehicle may have an HVAC circuit configured to provide general HVAC operations to the interior of vehicle in general, or some combination of these configurations.

The steering wheel heater 330 is configured to raise the temperature of a steering wheel in the vehicle or to ventilate the steering wheel to improve cooling. The steering wheel heater 330 can be used during a heating or cooling operation to augment the comfort of a driver of the vehicle. Although described using the term “heater,” the steering wheel heater 330 can operate to either heat or ventilate the steering wheel. Alternate embodiments include omit one of these options to cause the steering wheel heater 330 to act only as a steering wheel heater or steering wheel ventilator.

The one or more seat heaters 340, are configured to raise the temperature of one or more of the seats in the vehicle or to ventilate the one or more seats to improve cooling. The one or more seat heaters 340 can be used during a heating or cooling operation to augment the comfort of occupants located in seats corresponding to a given seat heater 340. Although described using the term “heater,” the one or more seat heaters 340 can both heat their respective seats or ventilate their respective seats. Alternate embodiments could omit one of these options to cause the one or more seat heaters 340 to act only as seat heaters or seat ventilators.

The ventilator 350 is configured to draw air into the vehicle without conditioning (i.e., heating or cooling). It may include a single ventilator circuits or multiple ventilator circuits. In an embodiment with multiple ventilator circuits, these circuits may be associated with one or more zones in an interior of the vehicle or with the steering wheel heater 330, with the one or more seat heaters 340, or the one or more neck warmers 360 in the vehicle. The ventilator 350 can be used during either a heating or cooling operation to augment the comfort of an occupant of the vehicle.

The one or more neck warmers 360 are located in the backs or headrests of seats in the vehicle and are configured to warm the necks of occupants in the vehicle or to ventilate the necks of the occupants. The one or more neck warmers 360 can be used during a heating or cooling operation to augment the comfort of occupants located in seats corresponding to a given neck warmers 360. Although described using the term “heater,” the one or more neck warmers 360 can both heat their respective necks or ventilate their respective necks. Alternate embodiments could omit one of these options to cause the one or more neck warmers 360 to act only as neck warmers or neck ventilators.

By operating the various comfort circuits 320 in addition to the vehicle HVAC circuits 310, the vehicle climate control system 100 can enhance the comfort of occupants of the vehicle. In addition, the comfort circuits 320 may alter an ideal temperature or temperature range for a given occupant. For example, during a heating operation a seat heater 340 might reduce an ideal temperature or temperature range in a corresponding zone in the vehicle for an occupant sitting in the seat associated with the corresponding seat heater 340.

Although not disclosed in the embodiment of FIG. 3, other devices can be included among the comfort circuits 320 in alternate embodiments. For example, in alternate embodiments the comfort circuits 320 could include hand rest heaters, door panel heaters, or the like.

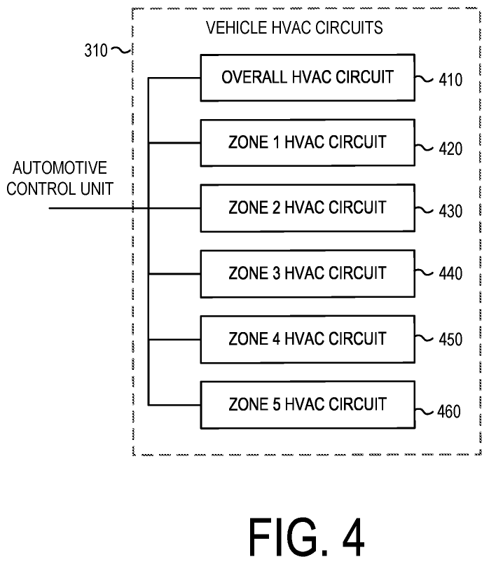

FIG. 4 is a block diagram of the vehicle HVAC circuits 310 of FIG. 3 according to disclosed embodiments. In the embodiments of FIG. 4, the interior of the vehicle is divided into five zones, five of which are designated as zone 1, zone 2, zone 3, zone 4, and zone 5, respectively. The five zones collectively form one overall zone that includes the entire interior of the vehicle. As shown in FIG. 4, the vehicle HVAC circuits 310 include in overall HVAC circuit 410, a zone 1 HVAC circuit 420, a zone 2 HVAC circuit 430, a zone 3 HVAC circuit 440, a zone 4 HVAC circuit 450, and a zone 5 HVAC circuit 460.

The overall HVAC circuit 410 is configured to provide HVAC services to the entire vehicle in general. In contrast, the zone 1 HVAC circuit 420, the zone 2 HVAC circuit 430, the zone 3 HVAC circuit 440, the zone 4 HVAC circuit 450, and the zone 5 HVAC circuit 460 are each configured to control the temperature in a corresponding zone, e.g., the zone 1 HVAC circuit 420 controls the temperature in zone 1, etc.

Although an overall HVAC circuit 410 is disclosed in the embodiment of FIG. 4, this is by way of example only. Alternate embodiments could omit this element from the HVAC circuits 310 and rely solely on the individual zone HVAC circuits for heating and cooling.

Furthermore, although FIG. 4 describes an embodiment with five zones and five zone HVAC circuits 420, 430, 440, 450, 460, the interior of the vehicle need not be divided into exactly five zones. In some embodiments there may be different numbers of zones. Furthermore, other embodiments can be configured such that not all zones have their own individual zone HVAC circuit. In such a system, general heating from other zone HVAC circuits or the overall HVAC circuit 410 are used to maintain a comfortable temperature in such a zone.

Each of the zone HVAC circuits 420, 430, 440, 450, 460 are controlled individually by the vehicle controller 110 to maintain a corresponding zone at a temperature that will be comfortable for the occupant are occupants of that zone. It should be understood that since the individual zones in the vehicle may not be isolated from each other, the heating and cooling from each individual zone HVAC circuit 420, 430, 440, 450, 460 may bleed over into other zones. However, by monitoring the temperature of the zones in the occupants of those zones, the operation of the various zone HVAC circuits 420, 430, 440, 450, 460 can be adjusted to keep the corresponding zones at a desired temperature or temperature range.

### Exemplary Vehicle

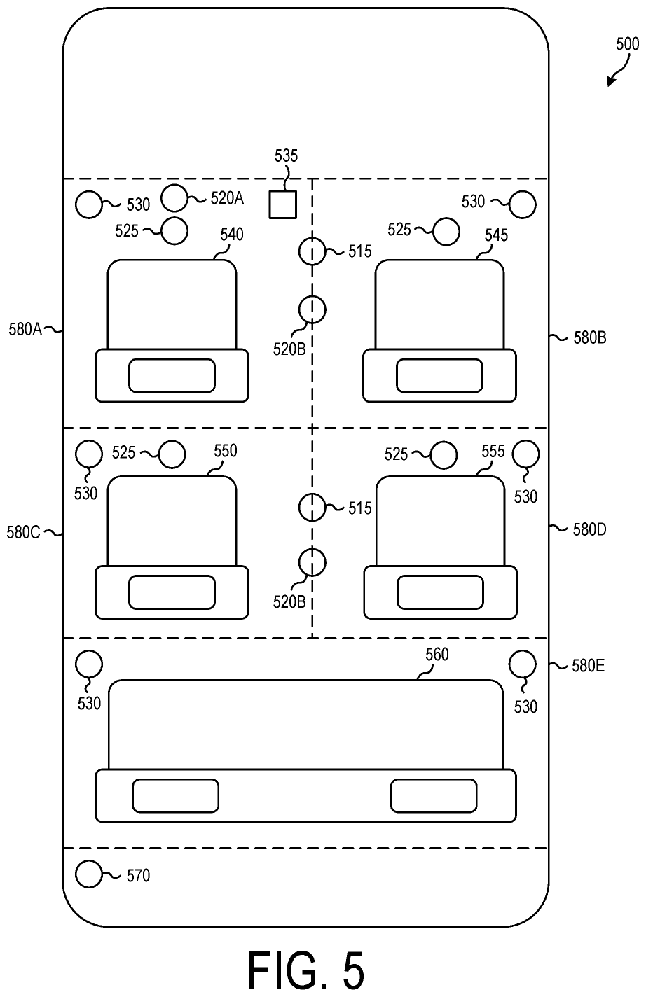

FIG. 5 is a plan view of a vehicle 500 whose climate is controlled by the vehicle climate control system of FIG. 1 according to disclosed embodiments. As shown in FIG. 5, the vehicle has three rows of seats, the front row including a driver's seat 540 and a front passenger seat 545, the middle row including a left middle passenger seat 550 and a right middle passenger seat 555, and the rear row including a single long rear seat 560. The interior of the vehicle 500 includes a variety of sensors such as radar sensors 515, camera sensors 520, thermal sensors 525, and microphone sensors 530. A human-machine interface 535 is provided on the dashboard of the vehicle 500 between the driver's seat 540 and the front passenger seat 545, and an external temperature sensor 570 is provided on the exterior of the vehicle 500.

In the embodiment of FIG. 5, the interior of the vehicle 500 is divided into five zones including a first zone 580A, a second zone 580B, a third zone 580C, a fourth zone 580D, and fifth zone 580E. The first zone 580A includes the driver seat 540; the second zone 580B includes the front passenger's seat 545; the third zone 580C includes the left middle passenger seat 550; the fourth zone 580D includes the right middle passenger seat 555; and the fifth zone 580E includes the rear seat 560.

Although five zones 580A, 580B, 580C, 580D, 580E are disclosed, the vehicle controller 110 could also group these individual zones 580A, 580B, 580C, 580D, 580E into combined zones for purposes of HVAC control. For example, an overall zone could be defined as including all five zones 580A, 580B, 580C, 580D, 580E; a front row zone could be defined as including zones 580A and 580B; and a middle zone could be defined as including zones 580C and 580D. Other combinations of zones 580A, 580B, 580C, 580D, 580E could be used to generate combined zones as desired.

The driver's seat 540 is provided for the driver of the vehicle. It is located directly opposite the steering wheel and main controls for the vehicle, e.g., gas and brake pedals. In this embodiment, the driver's seat 540 includes a seat warmer configured to heat the driver's seat 540 and a neck warmer located on the back or head rest of the driver's seat 540 configured to heat the neck of the person sitting in the driver seat 540. The steering wheel includes a steering wheel heater configured to heat the steering wheel. Alternate embodiments can omit all or some of the seat warmer, neck warmer, and steering wheel heater.

The front passenger seat 545, the left middle passenger seat 550, and the right middle passenger seat 555 are each provided for a different occupant of the vehicle. In this embodiment, each of the front passenger seat 545, the left middle passenger seat 550, and the right middle passenger seat 555 includes a seat warmer configured to heat the respective seat 545, 550, 555 and a neck warmer located on the back or head rest of the respective seat 545, 550, 555 configured to heat the neck of the person sitting in that seat 545, 550, 555. Alternate embodiments can omit any or all of the seat warmers and neck warmers.

The rear seat 560 is provided for multiple passengers of the vehicle. In this embodiment, the rear seat 560 is configured to contain three passengers but only has headrests for two of the passengers, omitting a headrest for any passenger in the middle of the rear seat 560. In this embodiment, the rear seat 560 does not include any seat warmers or neck warmers. Alternate embodiments can provide a seat warmer and/or a neck warmer for some or all occupant positions in the rear seat. In the alternative, a single seat warmer can be provided for the entire rear seat.

The radar sensors 515 correspond to the one or more radar sensors 130 in FIG. 1. They use radar to detect a variety of parameters including, the presence of occupants inside a vehicle, the position of occupants inside the vehicle, the number of occupants inside the vehicle, whether occupants have their seat belts fastened, whether an occupant is using a mobile phone, whether objects are being inserted from outside the vehicle through the windows of the vehicle, or any other parameter could be detectable using a radar sensor 130.

In the embodiment of FIG. 5, two radar sensors 515 are provided in the vicinity of the center of the interior of the vehicle 500. These two radar sensors 515 are configured together to gather radar sensor data from all the zones in vehicle. Alternate embodiments could use more or fewer radar sensors 515 or could eliminate the radar sensors 515 altogether. In addition, alternate embodiments could vary the position of the radar sensors 515 as needed.

The camera sensors 520 correspond to the camera sensors 140 in FIG. 1. They capture visual information along a variety of spectrums and can include visible light cameras or infrared cameras. The camera sensors 520 can detect the presence of an occupant, the location of an occupant, whether an occupant is drowsy, whether an occupant is using their mobile phone, or the like. They may be implemented as visible light cameras, infrared cameras, or a combination of both types of camera. An infrared camera allows for the gathering of this information in situations in which the interior of the vehicle is dark, e.g., at nighttime, in a tunnel, etc.

In the embodiment of FIG. 5, three camera sensors 520 are provided, a driver camera sensor 520A on the dashboard facing the driver's seat 540, and two central camera sensors 520B provided in the vicinity of the center of the interior of the vehicle 500. The driver camera sensor 520A is configured to gather image data regarding just the driver. The central camera sensors 520B are configured together to gather image data from all the zones in the vehicle 500, including driver image data, or in the alternative all the zones except for the zone containing the driver's seat 540.

In embodiment of FIG. 5, the driver camera sensor 520A is an infrared camera and the two central camera sensors 520B are combinations of visible light and infrared cameras. However, this is by way of example only. Alternate embodiments could change the types of cameras in each location as needed. In addition, alternate embodiments could use more or fewer camera sensors 520 or could eliminate the camera sensors 520 altogether. Alternate embodiments could also vary the position of the camera sensors 520 as needed.

The thermal sensors 525 correspond to the thermal sensors 120 in FIG. 1. They are configured to measure temperatures at various positions inside the vehicle. These thermal sensors 525 can be implemented, by way of example, using thermistors (i.e., thermally sensitive resistors), thermocouples, resistance temperature detectors (RTD), or infrared devices.

In the embodiment of FIG. 5, five thermal sensors 525 are provided, one for each of the five zones 580A, 580B, 580C, 580D, 580E. The thermal sensors 525 are each placed in or near its corresponding zone 580A, 580B, 580C, 580D, 580E such that it can make temperature measurements for the zone 580A, 580B, 580C, 580D, 580E and any occupants of the zone 580A, 580B, 580C, 580D, 580E. However, this is by way of example only. Alternate embodiments could use more or fewer thermal sensors 525 and could vary the position of the thermal sensors 525 as needed.

The microphone sensors 530 correspond to the microphone sensors 135 in FIG. 1. They operate to detect sound for a variety of purposes including voice recognition, identifying the presence of nearby sirens, detecting breaking glass, and the like. The microphone sensors 530 can be associated with speakers to allow communication to go in both ways between an occupant and the vehicle controller 110. The speakers can be arranged proximate to the microphone sensors 530 or in different locations as needed. In such embodiments, the number of speakers and microphone sensors need not be the same.

In the embodiment of FIG. 5, six microphone sensors 530 are provided, three on each side of the interior of the vehicle, with each row of seats having two microphone sensors 530, one on each side of the vehicle 500. However, this is by way of example only. Alternate embodiments could use more or fewer microphone sensors 530 or could eliminate the microphone sensors 530 altogether. Alternate embodiments could also vary the position of the microphone sensors 530 as needed.

The external temperature sensor 570 is a circuit configured to measure the temperature immediately outside the vehicle 500. It can be implemented using a conventional temperature sensor. The external temperature sensor 570 can be partially located inside of the vehicle 500, provided that it is properly configured to measure the outside temperature.

In the embodiment of FIG. 5, the external temperature sensor 570 is shown as being attached near the back of the vehicle 500. However, this is by way of example only. The external temperature sensor 570 could be attached at any appropriate location on the vehicle 500. Furthermore, alternate embodiments could omit the external temperature sensor 570 entirely. Such embodiments could either not use external temperature in its calculations or could obtain the external temperature in a different manner. For example, some embodiments could obtain a local temperature wirelessly from a local weather reporting source, e.g., a remote server.

The human-machine interface 535 corresponds to the human-machine interface 145 in FIG. 1. The human-machine interface 535 allows the occupants of the vehicle to provide inputs to and receive information from the vehicle controller 110.

In the embodiment of FIG. 5, the human-machine interface 535 is a touchpad located on the dashboard of the vehicle between the driver seat 540 and the front passenger seat 545. However, this is by way of example only. Alternate embodiments could change the placement of the human-machine interface 535 or could change its implementation to a different input/output device, e.g., a touch cluster, steering wheel buttons, buttons on the gear shift, etc. Furthermore, alternate embodiments could include additional human-machine interfaces 535 located at different locations throughout the interior of the vehicle 500 as desired.

### Data Tables

In order to control the temperature in each zone 580A, 580B, 580C, 580D, 580E, the vehicle controller 110 will operate the climate circuits 150 based on preference data supplied by an occupant of that zone in conjunction with comfort data stored in a memory 220 of the vehicle controller 110.

The preference data can include a desired operational mode (e.g., heating, cooling, or ventilation), a set point temperature or set point temperature range that indicates a desired temperature or temperature range, a desired comfort category, a desired comfort value, or a desired comfort value range. The desired operational mode may be heating, cooling, ventilation, or any suitable air-conditioning operation. The set point temperature or the set point temperature range are simply temperature values are temperature ranges that indicate a desired temperature or temperature range. Preference data received with respect to each zone will be stored in the memory 220 of the vehicle controller 110.

A comfort category is a descriptive indication of a temperature profile the occupant desires. For example, in one embodiment five comfort categories are provided: Cold, Cool, Comfortable, Warm, and Hot. These five comfort categories correspond to five different temperature ranges. For example, Cold could correspond to a temperature range of below 59° F.; Cool could correspond to a temperature range of 59° F.-68° F.; Comfortable could correspond to a temperature range of 68° F.-73° F.; Warm could correspond to a temperature range of 73° F.-78° F.; and Hot could correspond to a temperature range of above 78° F. However, these temperature ranges are provided by way of example. Alternate embodiments could employ different temperature ranges as desired.

The comfort value is a percentage that indicates a desired temperature, with a lower percentage indicating a relatively lower desired temperature and a higher percentage indicating a relatively higher desired temperature. An exact correlation of percentage to desired temperature can vary according to embodiments and may not even be necessary. Comfort value ranges are simply spans of comfort values, which can be used as an alternative to individual comfort values. In alternate embodiments, an occupant could provide a single percentage and the vehicle controller 110 could identify which of a set of predetermined percentage ranges the desired comfort percentage falls.

In one particular embodiment, a comfort value range of 0-20% could correspond to a temperature range of below 59° F. (i.e., the same as the “Cold” comfort category in the previous embodiment); a comfort value range of 20%-40% could correspond to a temperature range of 59° F.-68° F. (i.e., the same as the “Cool” comfort category in the previous embodiment); a comfort range of 40-60% could correspond to a temperature range of 68° F.-73° F. (i.e., the same as the “Comfortable” comfort category in the previous embodiment); a comfort range of 60-80% could correspond to a temperature range of 73° F.-78° F. (i.e., the same as the “Warm” comfort category in the previous embodiment); and a comfort range of 80-100% could correspond to a temperature range of above 78° F. (i.e., the same as the “Hot” comfort category in the previous embodiment). However, these temperature ranges are provided by way of example. Alternate embodiments could employ different temperature ranges as desired.

Furthermore, although the disclosed embodiments use five comfort categories and five comfort value ranges, this is by way of example only. Alternate embodiments could use more or fewer comfort categories or comfort value ranges. In addition, although the percentage for the comfort value ranges are equal for each range, i.e., 20% or ⅕ of the total range from 0 to 100, this is also by way of example. Alternate embodiments could use unequal comfort ranges.

In vehicles with multiple zones, different set point temperatures or comfort categories/comfort values/comfort ranges can be provided for the different zones. For example, in the embodiment of FIG. 5, the driver could input a set point temperature of 70° F. for the first zone 580A while the front passenger could input a set point temperature of 74° F. for the second zone 580B. In an alternate embodiment, a passenger in the left middle passenger seat 550 could select a comfort category of Comfortable, while a passenger in the right middle passenger seat 555 could select a comfort category of Warm.

The comfort data includes a variety of system parameters and indicates how a desired comfort level for the occupant of each zone can be achieved based on the inputted preference data and other environmental data, e.g., parameters from the various sensors 120, 130, 135, 140 in the vehicle climate control system 100. The comfort data may be stored in the form of a table in which a set of required system parameters can be identified to achieve a desired comfort level by inputting the preference data and other environmental data. In some embodiments, the system could use the various stored and received parameters to predict operational setting to achieve a predicted comfort level for an occupant.

In some embodiments, the comfort data could also include additional information that can be used to control the various comfort circuits 320 that are used in addition to the vehicle HVAC circuits 310. By controlling the various comfort circuits 320 appropriately, the vehicle controller 110 can get the climate circuits 150 to change the environment in a particular zone such that it will either increase the occupants predicted comfort level or achieve a desired comfort level.

Tables A, B, C, and D represent four possible implementations of comfort data that can be stored in the memory 220 of the vehicle controller 110. These tables vary based on what information the occupant of a given zone provides to the vehicle control. For example, in the embodiments of Tables A and B, the occupant provides a comfort category indicating their desired temperature range. In the embodiment of Table C, the occupant provides a comfort range or a comfort value that associated with the comfort range as a percentage value. Although not shown in Table C, in alternate embodiments ranges of comfort values can be used in place of individual comfort values. For example, instead of an occupant entering a comfort value of 40%, the argument could enter a comfort range of 20-40%. In the embodiment of Table D, the occupant provides a set point temperature. Although not shown in Table D, in alternate embodiments set point temperature ranges could be used instead of set point temperatures. Furthermore, these tables are meant to be exemplary of the data contained in the comfort data. They are not meant to indicate a comprehensive list of the data. The final comfort data may include additional data to cover multiple additional combinations of parameters.

Although FIG. 3 discloses that the comfort circuits 320 include a steering wheel heater 330 and a ventilator 350, Tables A, B, C, and D will not address the settings for these comfort circuits 320. However, this is for ease of disclosure only. An actual data table would include necessary parameters for all relevant HVAC circuits 310 as well as all comfort circuits 320 in the climate circuits 150.

As shown in the embodiment of Table A, the comfort data includes an HVAC set point temperature, a seat heater set point temperature, and a neck warmer set point temperature. This information is stored in Table A along with zone temperature data and comfort category data.

TABLE A

| ZONE | COMFORT | HVAC SET | SEAT HEATER | NECK WARMER |
|---|---|---|---|---|
| TEMP (° F.) | CATEGORY | POINT (° F.) | SET POINT (° C.) | SET POINT (° C.) |
| Below 59 | Cold | 71.6 | 37.4 | 32 |
| 59-68 | Cool | 73.4 | 35.6 | 32 |
| 68-73 | Comfortable | 75.3 | 33. | 32 |
| 73-78 | Warm | 77 | 32 | 33.8 |
| Above 78 | Hot | 78.8 | 32 | 35.6 |

During operation, the vehicle controller 110 will receive the zone temperature from a corresponding thermal sensor 125/525. The comfort category for the zone will have been previously received from a human-machine interface 145/535 and stored separately. With this information, as well as possible user-entered information, the vehicle controller 110 will determine what the HVAC set point temperature, seat heater set point temperature, and neck warmer set point temperature are and set these accordingly.

TABLE B

| ZONE | OUTDOOR | OCCUP. | COMF. | HVAC SET | SEAT SET | NECK SET |
|---|---|---|---|---|---|---|
| TEMP (° F.) | TEMP (° F.) | TEMP (° F.) | CATEG. | POINT (° F.) | POINT (° C.) | POINT (° C.) |
| Below 59 | Any | Any | Cold | 71.6 | 37.4 | 32 |
| 59-68 | Any | Below 68 | Cold | 73.4 | 37.4 | 32 |
| 59-68 | Any | 68-73 | Cool | 73.4 | 35.6 | 32 |
| 59-68 | Any | Above 73 | Comfortable | 75.2 | 33.8 | 32 |
| 68-73 | Below 59 | Any | Cold | 73.4 | 37.4 | 32 |
| 68-73 | 59-68 | Any | Cool | 75.2 | 35.6 | 32 |
| 68-73 | Above 68 | Any | Comfortable | 77 | 33.8 | 32 |
| 73-78 | Below 68 | Any | Cool | 75.2 | 35.6 | 32 |
| 73-78 | 68-73 | Any | Comfortable | 77 | 33.8 | 32 |
| 73-78 | Above 73 | Any | Warm | 78.8 | 32 | 33.8 |
| Above 78 | Any | Any | Hot | 78.8 | 32 | 35.6 |

As shown in the embodiment of Table B, the comfort data includes an HVAC set point temperature, a seat heater set point temperature, and a neck warmer set point temperature. This information is stored in Table B along with zone temperature data, outdoor temperature data, occupant temperature data, and comfort category data. In various embodiments the occupant temperature can be the actual occupant temperature or a temperature of the air immediately surrounding the occupant.

During operation, the vehicle controller 110 will receive the zone temperature and the occupant temperature from a corresponding thermal sensor 125/525 in a zone, and the outdoor temperature from an external temperature sensor 570. The comfort category will have been previously received for the zone from a human-machine interface 145/535 and stored separately. With this information, as well as possible user-entered information, the vehicle controller 110 will determine what the HVAC set point temperature, seat heater set point temperature, and neck warmer set point temperature are for the zone and set these accordingly. For example, if the zone temperature for a given zone was determined to be 70° F. (within the range of 68° F.-73° F.) and the comfort category for that zone was set to be Cool, the HVAC set point would be set to be 77° F., the seat heater set point would be set to be 32° C., and the neck warmer set point would be set to be 33.8° C. In some cases, the seat heaters 340 or the neck warmers 360 will be off in which case the seat set point entry or the neck set point entry will indicate that the seat heater 340 or neck warmer 360 will be off.

TABLE C

| ZONE | OUTDOOR | OCCUP. | COMF. | HVAC SET | SEAT SET | NECK SET |
|---|---|---|---|---|---|---|
| TEMP (° F.) | TEMP (° F.) | TEMP (° F.) | VALUE | POINT (° F.) | POINT (° C.) | POINT (° C.) |
| Below 59 | Any | 75 | 20% | 76 | 36 | 34 |
| 59-68 | Any | 75 | 40% | 77 | 35 | 34 |
| 68-73 | Any | 75 | 60% | 78 | 34 | 33 |
| 73-78 | Any | 75 | 80% | 79 | 33 | 32 |
| Above 78 | Any | 75 | 100% | 80 | 32 | 31 |
| 59-68 | Below 50 | Any | 20% | 76 | 36 | 34 |
| 59-68 | 50-70 | Any | 40% | 77 | 35 | 34 |
| 68-73 | 50-70 | Any | 60% | 78 | 34 | 33 |
| 73-78 | 50-70 | Any | 80% | 79 | 33 | 32 |
| 78-86 | 50-70 | Any | 100% | 80 | 32 | 31 |
| 68-73 | 70-90 | Any | 20% | 76 | 36 | 34 |
| 73-78 | 70-90 | Any | 40% | 77 | 35 | 34 |
| 78-86 | 70-90 | Any | 60% | 78 | 34 | 33 |
| Above 86 | 70-90 | Any | 80% | 79 | 33 | 32 |
| Above 86 | Above 90 | Any | 100% | 80 | 32 | 31 |

As shown in the embodiment of Table C, the comfort data includes an HVAC set point temperature, a seat heater set point temperature, and a neck warmer set point temperature. This information is stored in Table C along with zone temperature data, outdoor temperature data, occupant temperature data, and comfort values.

During operation, the vehicle controller 110 will receive the zone temperature and the occupant temperature from a corresponding thermal sensor 125/525 in a zone, and the outdoor temperature from an external temperature sensor 570. The comfort values will have been previously received the comfort value for the zone from a human-machine interface 145/535. With this information, as well as possible user-entered information, the vehicle controller 110 will determine what the HVAC set point temperature, seat heater set point temperature, and neck warmer set point temperature are and set these accordingly.

TABLE D

| ZONE | OUTDOOR | OCCUP. | COMF. | | HVAC SET |
|---|---|---|---|---|---|
| TEMP (° F.) | TEMP (° F.) | TEMP (° F.) | VALUE | MODE | POINT (° F.) |
| . . . | . . . | . . . | . . . | . . . | . . . |
| 67 | 40 | 98.4 | 65 | Heat | 75 |
| 67 | 40 | 98.5 | 65 | Heat | 74 |
| 67 | 40 | 98.6 | 65 | Heat | 73 |
| . . . | . . . | . . . | . . . | . . . | . . . |
| 72 | 43 | 98.5 | 65 | Heat | 74 |
| 72 | 43 | 98.6 | 65 | Heat | 73 |
| 72 | 43 | 98.7 | 65 | Heat | 72 |
| . . . | . . . | . . . | . . . | . . . | . . . |
| 76 | 52 | 98.9 | 65 | Heat | 72 |
| 76 | 52 | 99 | 65 | Heat | 71 |
| 76 | 52 | 99.1 | 65 | Heat | 70 |
| . . . | . . . | . . . | . . . | . . . | . . . |
| 78 | 42 | 98.5 | 87 | Heat | 80 |
| . . . | . . . | . . . | . . . | . . . | . . . |
| 77 | 83 | 98.6 | 43 | Cool | 70 |
| . . . | . . . | . . . | . . . | . . . | . . . |

As shown in the embodiment of Table D, the comfort data includes an HVAC set point temperature. Data for a seat heater set point temperature and a neck warmer set point temperature has been omitted for simplicity of disclosure, though it could be added in an alternate embodiment. This information is stored in Table D along with zone temperature data, outdoor temperature data, occupant temperature data, comfort values, and an operation mode. Table D is provided in partial form by way of example to show what entries could look like. However, given the size of Table D only a portion is provided. Unlike the embodiments of Tables A, B and C, the embodiment of Table D provides an entry for every combination of zone temperature, occupant temperature, outdoor temperature, comfort value, and mode, rather than using ranges.

During operation, the vehicle controller 110 will receive the zone temperature and the occupant temperature from a corresponding thermal sensor 125/525 in a zone, and the outdoor temperature from an external temperature sensor 570. The mode and comfort values for the zone will have been previously received via a human-machine interface 145/535 and stored separately. With this information, as well as possible user-entered information, the vehicle controller 110 will determine the appropriate HVAC set point temperature for the current zone and set it accordingly.

As shown in Tables A, B, C, and D, the comfort data they contain can be used by the vehicle controller 110, in conjunction with sensor data and occupant-provided data to set parameters for the climate circuits 150 that will provide a desired level of comfort to him occupant in a corresponding zone. In this way, the vehicle controller 110 can automatically maintain a desired comfort level without any input from the occupants, though inputs from the occupants regarding comfort levels or desired heating or cooling may also be accepted.

Furthermore, although the above description notes that the comfort categories/comfort values/comfort value ranges are entered prior to operation, these parameters can be varied by occupants both before and during operation. To the extent that these parameters are varied by an occupant during operation, the vehicle controller 110 will take these modified values into account when determining how to operate the climate circuits 150.

Although the comfort data in Tables A, B, C, and D includes comfort parameter information, this is used for determining the required system parameters to achieve the listed comfort parameters. Each zone will have associated preference data that identifies a comfort category/comfort value/comfort range associated with that zone and is stored separated from the comfort data table. This preference data can then be used in conjunction with the comfort data table to determine the necessary system parameters to achieve the desired comfort parameter defined in the preference data.

Although values are given in Tables A, B, C, and D, these are by way of example only and should not be considered restrictive in any way. The final data contained in the comfort data can vary by embodiment and can be determined in various ways. For example, in some embodiments, the various set points could be decided upon using human thermophysiology studies.

In addition, the vehicle controller 110 can be programmed to learn from a particular occupant's behavior, or at least a common occupant of a particular zone, and make adjustments to the system parameters based on predictive behavior, providing an even more personalized and comfortable experience for the occupant.

Tables A, B, C, and D are provided by way of example to show how comfort data and determinations of how to control the climate circuits 150 may be implemented in various disclosed embodiments. They are meant to be exemplary only and many variations can be used based on the needs of a system. For example, if additional comfort circuits were employed, additional columns could be used to indicate when they should be activated and what parameters should be used for their activation.

The above tables sometimes use adjacent ranges with the same upper and lower value. For example, Table A refers to the zone temperature ranges of 59-68° F. and 68-73° F. The use of overlapping values is used for convenience of disclosure only. In practice, vehicle controller 110 would have a mechanism for determining which temperature range to use should the temperature be measured to be exactly the overlapping value. For example, in one embodiment an exact value of 68° F. might be placed in the lower category rather than upper category.

### Operation of a Vehicle Climate Control System

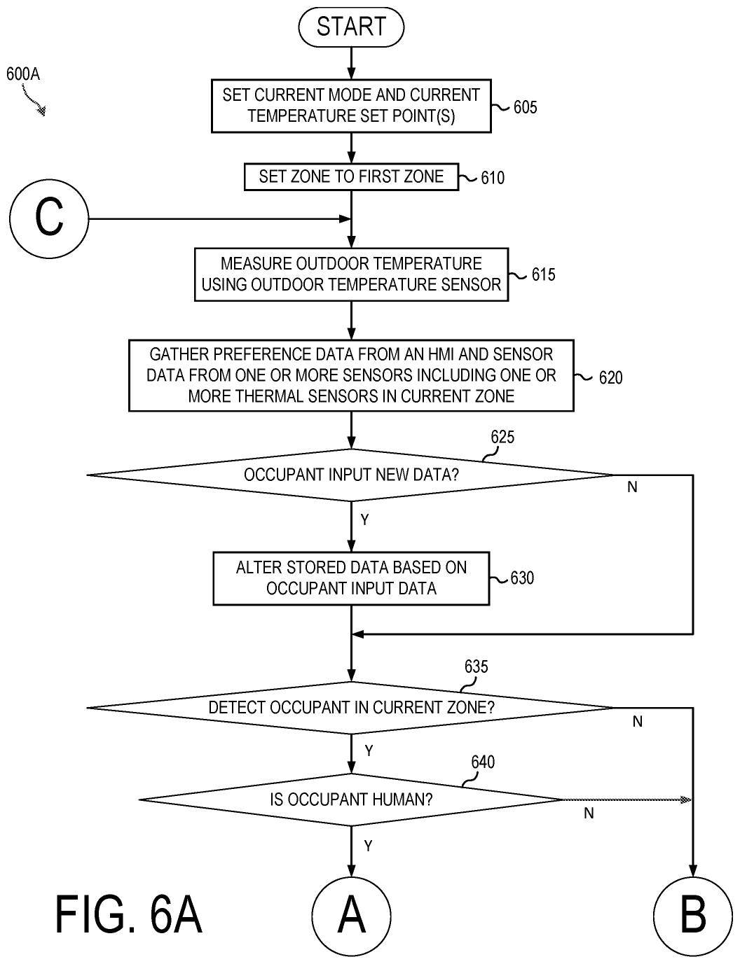

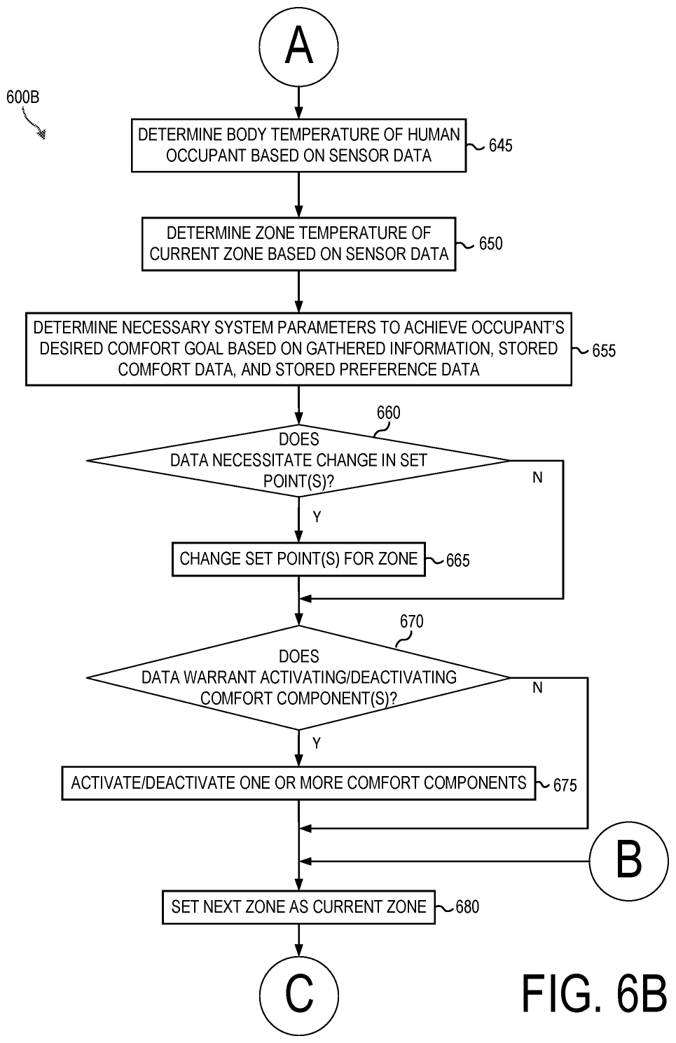

FIGS. 6A and 6B are a flowchart showing the operation 600A, 600B of a vehicle climate control system according to disclosed embodiments.

As shown in FIGS. 6A and 6B, the operation 600A, 600B begins by setting a current operational mode and current temperature set points for the various HVAC circuits that control the temperature inside a vehicle. (605) In addition, to the extent that any comfort circuits in the vehicle climate control system are set to be on as a default, either all the time or for a given operational mode, such comfort circuits would be activated and their parameters set accordingly.

A zone counter is then set to indicate a first zone. (610) Alternate embodiments could of course set the starting zone to any arbitrary zone. However, for the sake of simplicity, the operation 600A, 600B will be described using the first zone as a starting zone. In this way, any zone can arbitrarily be considered a first zone.

The operation then measures an outdoor temperature outside of the vehicle using an outdoor temperature sensor. (615) Alternate embodiments could employ a different process for obtaining the outdoor temperature. For example, one alternate embodiment could wirelessly contact a remote server or the like to obtain a measurement of the current outdoor temperature in the vicinity of the vehicle from a weather service.

The operation then gathers preference data from a human-machine interface, if any is received, and sensor data from one or more sensors, including temperature data from one or more temperature sensors. (620) If no new preference data is received, this aspect of the operation can be omitted.

The operation then determines whether an occupant has input new preference data for the current zone. (625) This new preference data could be new setpoints, a new comfort category, a new comfort value, a new comfort value range, or any information that could be used to modify the operation of the vehicle climate control system, particularly with respect to the current zone.

If the operation detects that the occupant has input new preference data, it will then alter the stored data based on the occupant's newly input preference data. (630) This can involve updating stored preference data associated with the current zone.

Then, whether no new preference data was detected or newly received preference data has been stored in memory, the operation determines whether it can detect an occupant in the current zone. (635) This determination can be done using one or more sensors in the vehicle. For example, this detection can be performed using visual data obtained from camera, radar data obtained from a radar, temperature data obtained from a thermal sensor, or any other detection information that can reasonably be used to determine whether there is an occupant in the current zone.

If an occupant is detected, the operation then determines whether the occupant is human. (640) In some cases, a vehicle operator may have a pet in the vehicle, e.g., a dog, and it can be important to differentiate between a human and an animal in the zone. This determination can be done using one or more sensors in the vehicle. For example, this detection can be performed using visual data obtained from camera, radar data obtained from a radar, temperature data obtained from a thermal sensor, or any other detection information that can reasonably be used to determine whether or not a detected occupant is human.

If no occupant is detected in the current zone, or if a detected occupant is determined to be nonhuman, the operation ends processing for the current zone and sets the next zone in rotation as the current zone. (680) Typically, this will be done by incrementing the zone from its current zone to the next in order. However, any rotation scheme for cycling through the zones in a vehicle can be used. Furthermore, when processing in a last zone is completed, the operation of setting a next zone as a current zone should return back to the first zone or whichever zone the operation started with.

If, however, an occupant is detected (Y 635) and is determined to be human (Y in 640), the operation determines the body temperature of the human occupant based on sensor data. (645) In an embodiment in which each zone is equipped with a corresponding thermal sensor, the vehicle climate control system measures the body temperature of the occupant using temperature data from the corresponding thermal sensor.

In alternate embodiments, the operation (645) can also determine certain body data regarding the human occupant based on sensor data. This body data can include an indication as to whether occupant is shivering, an indication as to whether the occupant as goosebumps on their skin, an indication as to whether the occupant is sweating, or any other information about the occupant that might serve to indicate as to whether the occupant is hot, cold, or otherwise uncomfortable due to environment. In other embodiments, this operation (645) can entirely replace the determining of the body temperature of the human occupant with a determination of body data.

The operation also determines a zone temperature of the current zone based on sensor data. (650) This zone temperature is simply the ambient temperature in the current zone. In an embodiment in which each zone is equipped with a corresponding thermal sensor, the vehicle climate control system also measures the zone temperature of the occupant using temperature data from the corresponding thermal sensor. In such embodiments, the same thermal sensor can be used to measure both the body temperature (or other body data) of the human occupant and the zone temperature of the current zone.

Once it determines the body temperature (or other body data) of the human occupant and the zone temperature of the current zone, the operation determines the necessary system parameters to achieve an occupant's desired comfort goal based on gathered information, stored comfort data, and stored preference data. The gathered information can include a current operational mode, the detected body temperature (or other body data), the detected zone temperature, and an outside temperature. (655) The controlled system parameters can include set point temperatures for any HVAC system associated with the current zone, flags or instructions to turn on or off a comfort circuit associated with the current zone, device parameters for any comfort circuit currently turned on or being instructed to be turned on, and a comfort indicator (e.g., a comfort category, comfort value, or comfort value range) indicative of the detected occupant's level of comfort.

Although in this embodiment the vehicle climate control system uses the current mode, the occupant's body temperature (or other body data), the zone temperature, and the outside temperature to determine the necessary system parameters to achieve the occupant's desired comfort goal, this is by way of example only. Alternate embodiments could make this decision based on either additional information or less information. For example, alternate embodiments could make this determination based solely on the occupant's body temperature (or other body data), or a combination of only the occupant's body temperature (or other body data) and the zone temperature. Adding additional considered data for making this decision may make the resulting determination more accurate. However even a small amount of data will allow a determination to be made.

The operation then determines whether any change in system parameters necessitates a change in set points for any of the climate circuits servicing the current zone. (660) This can include varying a set point for any HVAC circuit that services the current zone as well as varying a set point for any comfort circuit activated in the current zone, e.g., a seat heater, a neck warmer, a door panel heater, and arm warmer, etc.

If the operation does necessitate a change in any set points, the system then proceeds to change those setpoints for the zone. (665)

The operation also determines whether the received sensor data, along with all the other data stored by the vehicle climate control system warrants activating or deactivating any comfort circuit associated with the current zone. (670) for example, the various data may warrant turning on or off the neck warmer or a door panel heater.

If the operation determines that one or more comfort components should be activated or deactivated, it then proceeds to activate or deactivated one or more comfort components, as required by the prior determination. (675) If a comfort component is activated, it should also be provided with any initial data required for its operation, e.g., a set point temperature.

Once the operation has determined whether any set points should be changed and whether any comfort components should be activated or deactivated, and has implemented those changes, or has determined that no such changes need to occur, the vehicle climate control system ends processing for the current zone and sets the next zone in rotation as the current zone. (680) The operation then returns to measuring the outdoor temperature (615) and gathering preference data and temperature data (620) for the new zone, and processing continues.

In this way, once the operation is started, it continues to cycle through each of the zones in the vehicle, controlling the climate individually in each zone based at least in part on temperature data received from a thermal sensor associated with each zone.

### Method of Identifying an Unattended Child in a Vehicle

In addition to determining how climate circuits in a vehicle should be controlled, a vehicle climate control circuit can also use its components to identify whether an unattended child has been left in a vehicle.

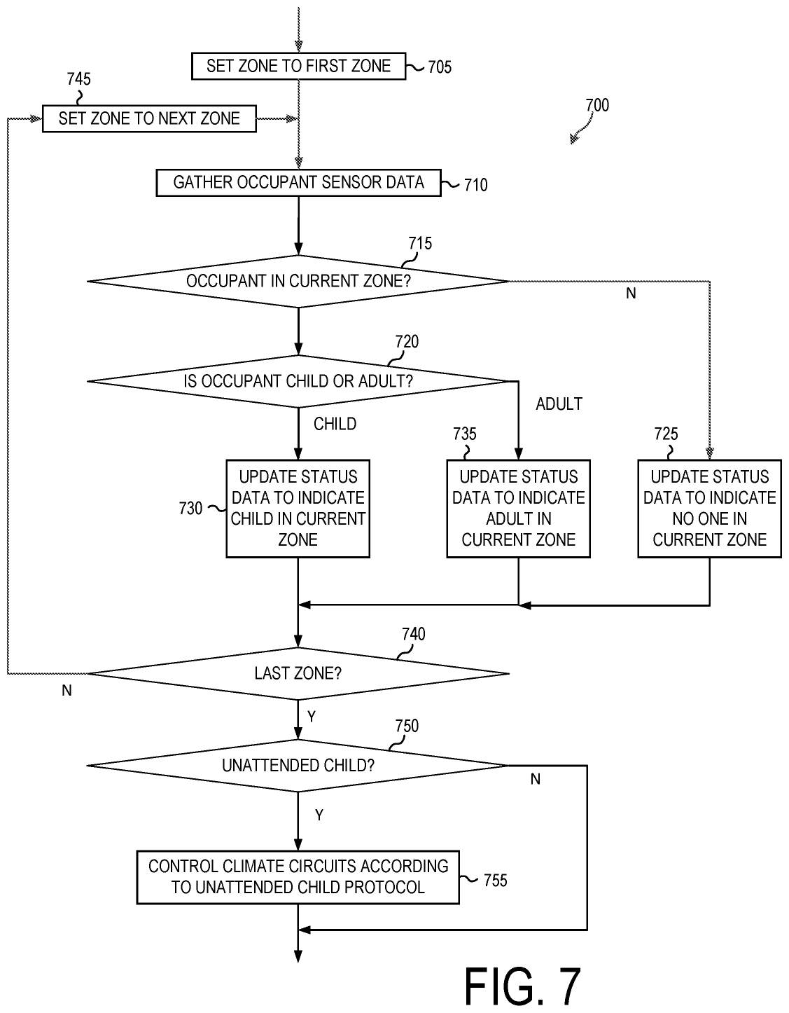

FIG. 7 is a flowchart showing an operation 700 of identifying an unattended child in a vehicle according to disclosed embodiments.

As shown in FIG. 7, this operation begins by setting a current zone to a first zone. (705) Alternate embodiments could of course set the starting zone to any arbitrary zone. However, for the sake of simplicity, the operation 700 will be described using the first zone as a starting zone.

The operation then gathers occupant sensor data from the various sensors associated with the current zone. (710) The sensors can include thermal sensors, video sensors, radar sensors, or the like. The gathered occupant data can include a temperature of the occupant, an image of the occupant, a track of movements of the occupant, etc.

The operation then determines whether there is an occupant in the current zone based on the gathered occupant sensor data. (715) This can be achieved by considering temperature, image, or movement data in the current zone and determining whether this data is consistent with there being in occupant.

If the operation determines that no occupant is in the current zone, it updates a status marker to indicate that no one is present in the current zone. (725) this status marker can be saved in a memory in an associated vehicle controller.

Once an occupant has been detected in the current zone, the operation determines whether the detected occupant is a child or an adult. (720) This determination can be achieved by considering temperature, image, or movement data in the current zone and determining whether this data is consistent with a detected occupant being a child or an adult.

If the operation determines that the detected occupant is a child, it updates the status data to indicate that there is a child in the current zone. (730) If, however, the operation determines that the detected occupant is an adult, it updates the status data to indicate that there is an adult in the current zone. (735)

Although not noted in FIG. 7, the operation can also determine whether a detected occupant is a human being subsequent to detecting the presence of an occupant. If the operation determines that a detected occupant is not human, it can treat this determination as a determination that there is no one in the current zone (see operation 725) or it could treat this determination as a determination that there is a child in the current zone (see operation 730). By treating an animal like a child, the system can also prevent the leaving of an unattended pet in a car, which can also be dangerous for the pet in inclement weather.

Once it has determined whether there is an occupant in the current zone and if there is an occupant, whether the occupant is a child or adult, and has updated the status data to indicate the results of these determinations, the operation determines whether the current zone is the last of the possible zones to consider. (740)

If the operation determines that the current zone is not the last zone, it sets the current zone to the next zone (745), gathers occupant sensor data for the new zone (710), and continues processing for the new zone. In this way, the operation will cycle through all the zones in the vehicle.

If, however, the operation determines that the current zone is the last zone (740), it then determines whether there is an unattended child in the vehicle. (750) This can be achieved by looking at the stored status data and determining whether it indicates that there is a child in one of the zones in the vehicle and no adult in any of the zones in the vehicle. If this is the case, the operation concludes that there is an unattended child in the vehicle. If, however, it determines that there is either no child in any zone in the vehicle, or that there is a child in one of the zones of the vehicle but also an adult in one of the zones in the vehicle, it will conclude that there is no unattended child in the vehicle.

If the operation determines that there is an unattended child in the vehicle, it will then control the climate circuits according to an unattended child protocol. (755) The unattended child protocol can involve instructing climate circuits in the vehicle to maintain the vehicle to a comfortable temperature, regardless of a lack of instructions to do so. It may also instruct the vehicle engine to turn on to allow the climate circuits to operate. In some embodiments the unattended child protocol may also trigger a message being sent to either an emergency number, a designated contact number, or both indicating that a child has been left unattended in the vehicle.

The unattended child determination can be made subsequent to the vehicle being turned off, which is a common time at which a child may inadvertently be left unattended in a vehicle. In this case, the vehicle may either remain on or may turn itself on to provide power to the sensors and processor that will perform the unattended child determination. In alternate embodiments, the necessary components can operate on battery power for sufficient time to make the necessary determinations.

In this way a determination can be made as to whether a child is being inadvertently left unattended in a vehicle and steps can be taken to make sure that the temperature in the vehicle is maintained such that the child will remain safe.

### CONCLUSION

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled. The various circuits described above can be implemented in discrete circuits or integrated circuits, as desired by implementation.

1. A vehicle climate control system, comprising:
a vehicle controller;
a memory configured to store one or more temperature set points for the inside of a vehicle;
a plurality of vehicular sensors including one or more thermal sensors configured to collect temperature data; and
a plurality of climate circuits configured to control a climate inside the vehicle,
wherein
the one or more thermal sensors are each configured to measure a body temperature of an occupant and an internal temperature of an interior of the vehicle, and
the vehicle controller is configured to control the plurality of climate circuits based on the body temperature of the occupant, at least one of the one or more temperature set points, and the internal temperature of an interior of the vehicle.

2. The vehicle climate control system of claim 1, wherein
the climate circuits include one or more vehicle heating, ventilation, and air-conditioning (HVAC) circuits and one or more comfort circuits.

3. The vehicle climate control system of claim 2, wherein
the comfort circuits include at least one of a steering wheel heater, a seat heater, a ventilator, and a neck warmer.

4. The vehicle climate control system of claim 2, wherein
the interior of the vehicle is divided up into two or more zones, and
the vehicle HVAC circuits include two or more zone HVAC circuits, each of the two or more zone HVAC circuits corresponding to one of the two or more zones.

5. The vehicle climate control system of claim 1, wherein
the interior of the vehicle is divided up into two or more zones, and
the climate circuits include two or more vehicle heating, ventilation, and air-conditioning (HVAC) circuits, each of the two or more HVAC circuits corresponding to one of the two or more zones,
the one or more thermal sensors include two or more thermal sensors, each of the two or more thermal sensors corresponding to one of the two or more zones,
the two or more thermal sensors are each configured to measure a body temperature of an occupant in a corresponding zone and an internal temperature of the interior of the vehicle in the corresponding zone,
the vehicle controller is configured to control each of the two or more HVAC circuits based the body temperature of the occupant in the corresponding zone, the internal temperature of an interior of the vehicle in the corresponding zone, and at least one of the one or more temperature set points corresponding to the zone.

6. The vehicle climate control system of claim 1, further comprising:
an external temperature sensor configured to measure an external temperature immediately outside of the vehicle,
wherein, the vehicle controller is configured to control the plurality of climate circuits based on the body temperature of the occupant, the internal temperature of an interior of the vehicle, at least one of the one or more temperature set points, and the external temperature immediately outside of the vehicle.

7. The vehicle climate control system of claim 1, further comprising:
a human-machine-interface configured to receive information and instructions from the occupant and to provide the information and the instructions from the occupant to the vehicle controller,
wherein, the vehicle controller is configured to control the plurality of climate circuits based on the body temperature of the occupant, the internal temperature of an interior of the vehicle, at least one of the one or more temperature set points, and the information and instructions received from the occupant.

8. A method of controlling a vehicle climate control system, the method comprising:
setting a current operation mode for a vehicle and one or more zone temperature set points for the vehicle, an interior of the vehicle being divided into one or more zones and the one or more zone temperature set points each corresponding to one of the one or more zones;
receiving first preference data corresponding to a first zone in the vehicle, the first zone being selected from the one or more zones, the first preference data indicating a first desired temperature or first desired temperature range for the first zone;
gathering data from one or more internal sensors inside the vehicle, the internal sensors including at least one thermal sensor;
identifying the presence of a first occupant in the first zone using information from the one or more internal sensors;
determining a first temperature of the first occupant using information from the at least one thermal sensor;
determining a first zone temperature of the first zone using information from the at least one thermal sensor;
determining required changes to the system parameters to maintain the first desired temperature or first desired temperature range in the first zone based on the first preference data, the first body temperature, and at least one of: the current operation mode, a first set point selected from the one or more zone temperature set points and corresponding to the first zone, and the first zone temperature; and
modifying the system parameters based on the determining of required changes to the system parameters to maintain the first desired temperature or the first desired temperature range.

9. The method of controlling the vehicle climate control system of claim 8, further comprising:
measuring an outdoor temperature immediately outside of the vehicle,
wherein the determining of the required changes to the system parameters is performed based on the first preference data, the first body temperature and at least one of: the current operation mode, the first set point, the estimated first body temperature, the first zone temperature, and the outdoor temperature.

10. The method of controlling the vehicle climate control system of claim 8, further comprising:
gathering first body data of the first occupant using information from the at least one or more internal sensors, the first body data identifying a physical parameter of the first occupant,
wherein the determining of the required changes to the system parameters to maintain the first desired temperature or the first desired temperature range in the first zone is performed based on the first preference data, the first body temperature, the first body data, and at least one of: the current operation mode, a first set point selected from the one or more zone temperature set points and corresponding to the first zone, and the first zone temperature.

11. The method of controlling the vehicle climate control system of claim 8, wherein
the first body data includes one of: an indication of whether the first occupant is shivering, an indication of whether the first occupant has goosebumps on their skin, and an indication of whether the first occupant is sweating.

12. The method of controlling the vehicle climate control system of claim 8, further comprising:
determining that the first occupant is human using information from the one or more internal sensors prior to the estimating of the first body temperature of the first occupant.

13. The method of controlling the vehicle climate control system of claim 8, wherein
the operations of gathering the data from the one or more internal sensors inside the vehicle, identifying the presence of the first occupant in the first zone, determining the first body temperature of the first occupant, determining the first zone temperature, determining of the required changes to the system parameters to maintain the desired temperature or temperature range, and modifying the system parameters based on the determining of required changes to the system parameters are repeated throughout operation of the vehicle climate control system.

14. The method of controlling the vehicle climate control system of claim 8, further comprising:
receiving second preference data corresponding to a second zone in the vehicle, the second zone being selected from the one or more zones and being different from the first zone, the second preference data indicating a second desired temperature or second temperature range for the second zone;
identifying the presence of a second occupant in the second zone using information from the one or more internal sensors;
determining a second body temperature of the second occupant using information from the at least one thermal sensor;
determining a second zone temperature of the second zone using information from the at least one thermal sensor;
determining required changes to the system parameters to maintain the second desired temperature or the second desired temperature range in the second zone based on the second preference data, the second body temperature, and at least one of: the current operation mode, a second set point selected from the one or more zone temperature set points and corresponding to the second zone, and the second zone temperature; and
modifying the system parameters based on the determining of required changes to the system parameters to maintain the second desired temperature or the second desired temperature range.

15. The method of controlling the vehicle climate control system of claim 8, further comprising:
determining that activation of one or more comfort components is warranted based on the first preference data, the first body temperature, and at least one of: the current operation mode, a first set point selected from the one or more zone temperature set points and corresponding to the first zone, and the first zone temperature; and
activating one or more comfort components after determining that the activation of the one or more comfort components is warranted.

16. The method of controlling the vehicle climate control system of claim 8, further comprising:
determining that modifying one or more comfort parameters relating to one or more comfort components is warranted based on the first preference data, the first body temperature, and at least one of: the current operation mode, a first set point selected from the one or more zone temperature set points and corresponding to the first zone, the estimated first body temperature, and the first zone temperature; and
modifying the one or more comfort parameters after determining that modifying the one or more comfort parameters relating to the one or more comfort components is warranted.

17. The method of controlling the vehicle climate control system of claim 8, further comprising:
determining that the first occupant is a child using information from the one or more internal sensors;
determining that the vehicle does not contain any adult occupants using information from the one or more internal sensors; and
controlling one or more climate circuits in the vehicle according to an unattended child protocol that maintains the first zone temperature within a predetermined range after determining that the first occupant is a child, and that the vehicle does not contain any adult occupants.

18. A computer system configured to control a vehicle climate control system including one or more climate circuits configured to control a climate in an interior of a vehicle and one or more internal sensors inside the vehicle that include one or more thermal sensors, the system comprising:
a communication interface configured to transmit and receive data and control signals to and from the one or more internal sensors and the one or more climate circuits;
a memory configured to store data and instructions; and
a processor cooperatively operable with the communication interface and the memory, and configured to facilitate:
setting a current operation mode for the vehicle and one or more zone temperature set points for the vehicle, the interior of the vehicle being divided into one or more zones and the one or more zone temperature set points each corresponding to one of the one or more zones;
receiving first preference data corresponding to a first zone in the vehicle, the first zone being selected from the one or more zones, the first preference data indicating a first desired temperature or first desired temperature range for the first zone;
receiving sensor data from the one or more internal sensors;
identifying the presence of a first occupant in the first zone of the vehicle using the sensor data from the one or more internal sensors;
determining a first body temperature of the first occupant using information from the at least one thermal sensor;
determining a first zone temperature of the first zone using information from the at least one thermal sensor;
determining required changes to the system parameters to maintain the first desired temperature or first desired temperature range in the first zone based on the first preference data, the first body temperature, and at least one of: the current operation mode, a first set point selected from the one or more zone temperature set points and corresponding to the first zone, and the first zone temperature; and
modifying the system parameters based on the determining of required changes to the system parameters to maintain the first desired temperature or the first desired temperature range.

19. The computer system of claim 18, wherein the processor is further configured such that the processor repeats the operations of gathering the data from the one or more internal sensors inside the vehicle, identifying the presence of the first occupant in the first zone, determining the first body temperature of the first occupant, determining the first zone temperature, determining of required changes to the system parameters to maintain the desired temperature or temperature range, and modifying the system parameters based on the determining of the required changes to the system parameters throughout operation of the vehicle climate control system.

20. The computer system of claim 18, wherein the processor is further configured to facilitate:
receiving second preference data corresponding to a second zone in the vehicle, the second zone being selected from the one or more zones and being different from the first zone, the second preference data indicating a desired temperature or temperature range for the second zone;
identifying the presence of a second occupant in the second zone using information from the one or more internal sensors;
determining a second body temperature of the second occupant using information from the at least one thermal sensor;
determining a second zone temperature of the second zone using information from the at least one thermal sensor;
determining required changes to the system parameters to maintain the second desired temperature or the second desired temperature range in the second zone based on the second preference data, the second body temperature, and at least one of: the current operation mode, a second set point selected from the one or more zone temperature set points and corresponding to the second zone, and the second zone temperature; and
modifying the system parameters based on the determining of required changes to the system parameters to maintain the second desired temperature or the second desired temperature range.
